(19) United States
(12) Patent Application Publication
(10) Pub. No.: US 2009/0162598 A1
(43) Pub. Date: Jun. 25, 2009

(54) INSULATED CORE STRUCTURE OF A PLATE

(76) Inventor: Shu-Fen YANG, Gangshan Township (TW)

Correspondence Address: EGBERT LAW OFFICES, 412 MAIN STREET, 7TH FLOOR, HOUSTON, TX, 77002, US

(21) Appl. No.: 11/961,546

(22) Filed: Dec. 20, 2007

(51) Int. Cl. B32B 3/02

(52) U.S. Cl. 428/68

(57) ABSTRACT

The insulated core structure of a plate is composed of at least one insulated core layer and the surface layer connecting to the outside of the insulated core layer. The insulated core layer is made of a convex core plate and the covering plate connecting to the outside of the convex core plate, which is plate or thin shell plate with an interval concave part. The surface is glued to the exterior surface of covering plate of the insulated core layer with adhesive. The materials can be light and hard fiberglass reinforced plastics, so that the weight of plate can be reduced greatly, the plates being much lighter and easier to handle. In addition, the multi-rig edge conformation of the convex core plate brings about optimal structural support strength, and the plate is provided with light weight and practical durability with sufficient stiffness.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a kind of plate, and more particularly to an innovative plate with an improved insulated core structure.

2. Description of Related Art Including Information Disclosed Under 37 CFR 1.97 and 37 CFR 1.98.

At present, plates used for desks in the market include wood, composite materials and solid core stone panels, each having different qualities. For example, for desks, stone panels with natural stone vein have good quality, hardness and waterproof property. The stone panel plays an important role in furniture products.

However, there are some disadvantages to stone desks, including great weight, high transportation cost and high material costs.

Currently, stone desk panels composed of composite materials have been developed, which reduce the strength of the integral desk structure. Its solidity and durability are also affected greatly. In addition, though honeycomb type organization has been applied to construct insulated core structures, several stones are still combined into a stone desk panel on outside surface. In some kinds of structures, the honeycomb type organization is composed of several rib plates as one multi-hole honeycomb type structure, which lies above honeycomb type organization and insulated core structure. Lines and faces contact and join at a lower covering plate, with a comparatively smaller contact area, thus the strength of the formed insulated core structure is weaker, so that support stiffness strength of the plate structure of made and shaped stone desk plate is weaker, and durability is reduced as well.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

With the insulated core layer 10 composed of convex core plate 11 and covering plate 12, the materials can be light and hard glass-fiber reinforced plastics. The weight of plate A can be reduced greatly, so that the materials can be lighter and easier to handle. Practical progress and better industrial economic benefits of transportation and material cost can be effectively maximized.

With the insulated core layer 10 composed of convex core plate 11 and covering plate 12, multi-rib edge conformation of the convex core plate 11 can be used. Convex core plate 11 of interval concave part 110, displayed in FIG. 2, and the connection of faces, when convex core plate 11 are combined with covering plate 12, make obtained contact area greater. Thus, the present invention can obtain optimal structural support strength, when the formed insulated core layer 10 is compared to the prior art honeycomb type organization structure. The plate A can possess practical durability of enough stiffness with small weight.

FIG. 4 depicts the opposite angle location of convex part 111 in convex core plate 11 being connected to convex part 111 through rib edge 112, forming a shaped mold product of said convex core plate 11, so that said convex core plate possesses better lengthwise and widthwise support strength.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a combined perspective view of the present invention.

FIG. 2 shows an exploded perspective view of the present invention.

FIG. 3 shows a schematic view of the present invention.

FIG. 4 shows an enlarged schematic view of the partial convex core plate of the present invention.

FIG. 5 shows a sectional view of the insulated core layer combination of the present invention.

FIG. 6 shows another sectional view of the combined present invention.

FIG. 7 shows another partially enlarged sectional view of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

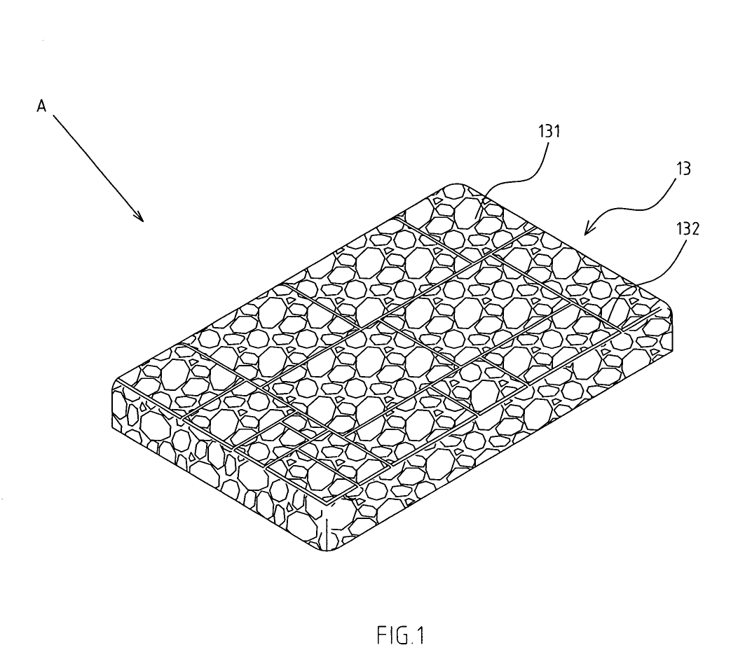

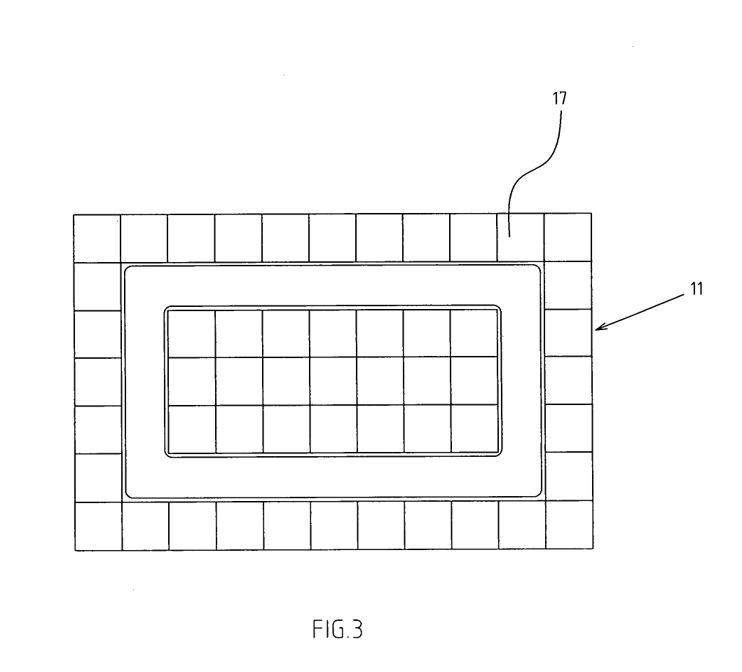

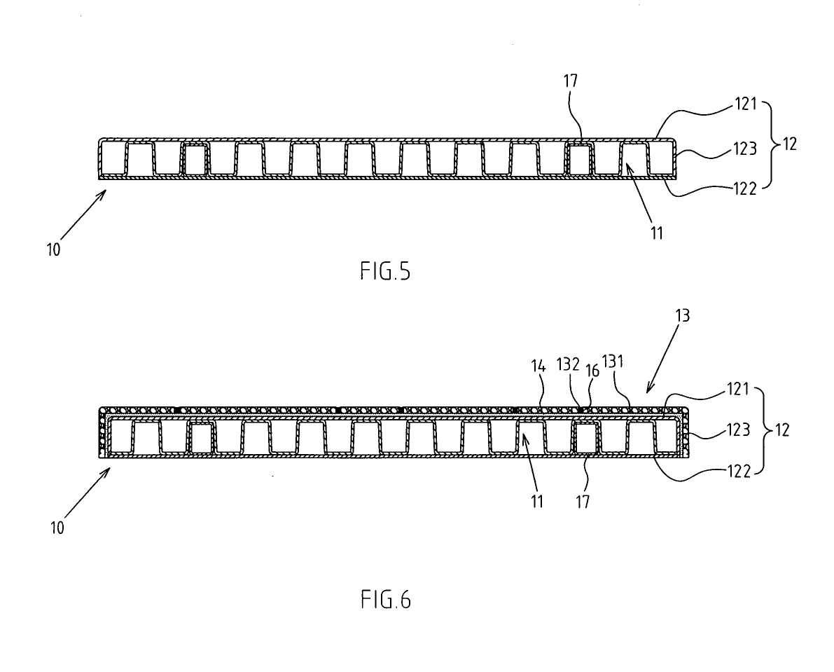

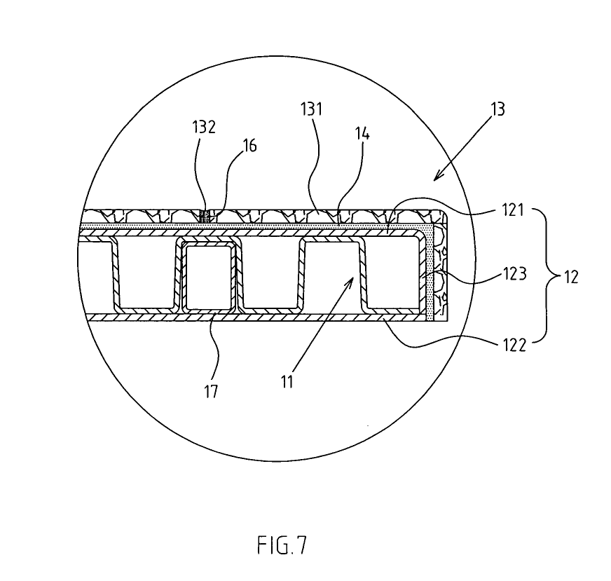

FIGS. 1-7 depict preferred embodiments of improved insulated core structure of plate in the present invention. The embodiments are provided only for explanatory purposes with respect to the patent claims. The present invention only applies stone desk panels as a single embodiment for explanation purposes.

The plate A used for a stone desk contains at lease one insulated core structure 10 and surface layer 13 connecting the outside of the insulated core structure. The insulated core structure 10 contains convex core plate 11 and covering plate 12 connecting the outside of the convex core plate 11. The convex core plate is a plate or thin shell plate with an interval concave part. Covering plate 12 of said insulated core structure can be comprised of one upper covering plate 121 and one lower covering plate 122, both or either of which is applied to form a lateral frame 123, to enclose convex core plate 11.

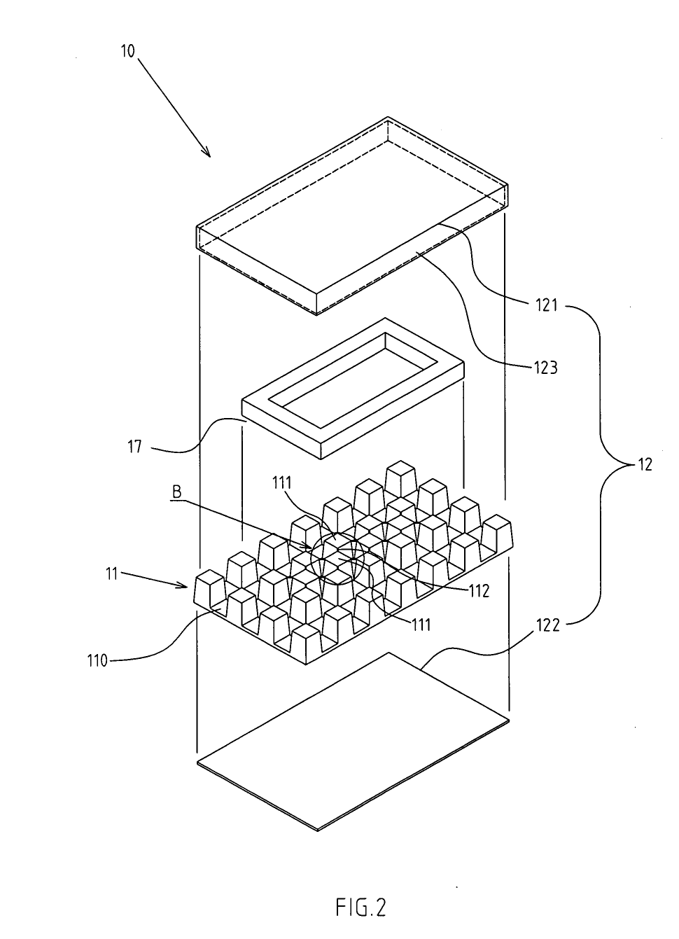

FIG. 2 depicts the convex core plate 11 as a plate or thin shell plate with interval part 110, and at lease one fixed frame 17, fixed at intervals along concave part 110. Said thin shell body generally refers to molded product which can make the material shape in the convex interval setting. When the method involves setting several intervals and orderly arranging, a column type mold is used to make materials. The convex core plate 11 is composed of fiberglass reinforced plastics (namely Fiberglass Reinforced Plastics, FRP for short).

The covering plate 12 of said insulated core structure 10 is constituted by fiberglass reinforced plastics (namely Fiberglass Reinforced Plastics, FRP for short).

Said surface layer 13 is made up of several stone panels 131, among which joint 132 is formed. The joint 132 among the stone panels 131 is filled with seam filling.

Said structure is applied to make up design, and herein the use and operation of the present invention is stated as follows:

FIGS. 1, 2 and 3 depict that when said plate A is made, interval concave part 110 of said convex core plate 11 is used to form said convex core plate 11 according to beforehand interval arrangement of fixed frame 17, which can be held therein. Upper and lower covering 121 and 122 of covering plate 12 is used to respectively hold said convex core plate 11, and lateral frame part 123 of either of upper and lower covering 121 and 122 is used to enclose a lateral part frame at a lateral part of convex core plate 11, which can be held inside covering plate 12 to form said insulated core structure 10. The setting of fixed frame 17 can make the structure of insulated core structure 10 more solid and durable.

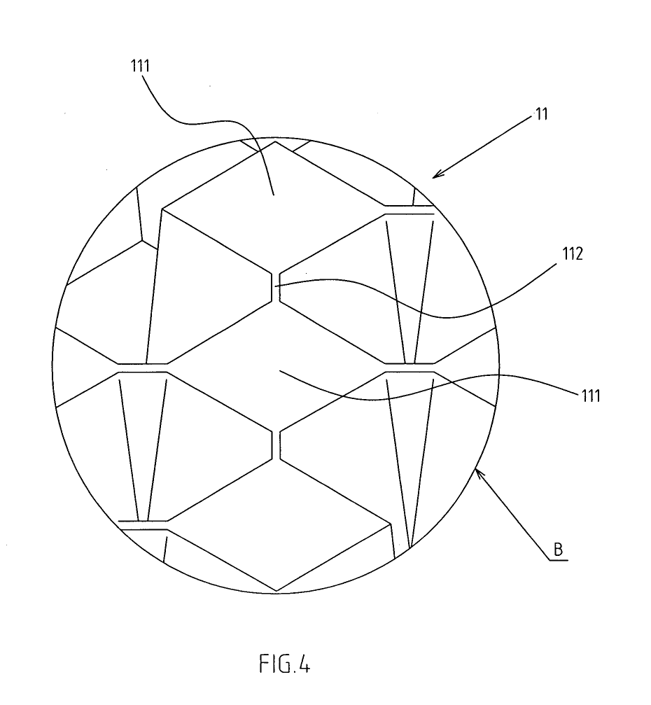

FIG. 4 shows amplified image of B part of convex core plate 11 stated in FIG. 2. In the figure, the opposite angle location of each convex part 111 in convex core plate 11 is connected to a convex part 111 through rib edge 112. That is, with the connection relation, said convex core panel will form shaped mold products. Therefore, said convex core panel 11 possesses better lengthwise and widthwise support strength.

FIGS. 5, 6 and 7 further show that made insulated core structure 10 is connected to surface layer 13 and composed of several stone panels 131. Any side of covering plate 12 of insulated core structure 10 is glued to surface layer 13 with adhesive 14, to form said plate A.

Additional explanations are that said convex core plate 11 with interval concave part 110 can form said insulated core structure 10 without adding fixing frame 17. The constituted plate A may possess quite favorable support stiffness strength and practical durability.

Insulated core structure 10 of said plate A also applies to the application field of products to be made up of other materials.

1. An insulated core structure of a plate, comprising:
at least one insulated core layer comprising a convex core plate and a covering plate, said covering plate connecting to an outside of said convex core plate, said convex core plate being a plate or shell plate with an interval concave part; and
a surface layer connecting to an outside of said insulated core layer.

2. The insulated core structure defined in claim 1, wherein said convex core plate is comprised of fiberglass reinforced plastics.

3. The insulated core structure defined in claim 1, wherein said covering plate of said insulated core layer is comprised of one upper covering plate and one lower covering plate, both or either forming a lateral frame enclosing sides of said convex core plate.

4. The insulated core structure defined in claim 1, wherein said covering plate of said insulated core layer is comprised of fiberglass reinforced plastics.

5. The insulated core structure defined in claim 1, wherein said surface layer is comprised of stone panels, said surface layer having a gap therein.

6. The insulated core structure defined in claim 5, wherein said gap among said stone panels is filled with seam filling.
